(19) United States
(12) Patent Application Publication
(10) Pub. No.: US 2008/0262657 A1
(43) Pub. Date: Oct. 23, 2008

(54) SYSTEM AND METHOD FOR CONTROLLING ADJUSTABLE FURNITURE

(75) Inventors: Phil Howell, Mount Vernon, MO (US); Nicholas S. Tsigolaroff, Granite City, IL (US); Kevin J. Kline, St. Charles, MO (US); Timothy M. Diehl, St. Peters, MO (US); Darren W. Hacker, St. Louis, MO (US); Thomas P. Long, Webb City, MO (US)

Correspondence Address: WOOD, HERRON & EVANS, LLP, 2700 CAREW TOWER, 441 VINE STREET, CINCINNATI, OH, 45202, US

(73) Assignee: L&P PROPERTY MANAGEMENT COMPANY, South Gate, CA (US)

(21) Appl. No.: 12/103,511

(22) Filed: Apr. 15, 2008

Related U.S. Application Data
(60) Provisional application No. 61/035,550, filed on Mar. 11, 2008.
(60) Provisional application No. 60/912,277, filed on Apr. 17, 2007.

(51) Int. Cl. G01M 1/38; A47C 20/00

(52) U.S. Cl. 700/275; 5/630

(57) ABSTRACT

A system and methods for controlling adjustable furniture 60. The adjustable furniture 60 may be controlled by a control unit 34 in communication with a remote controller 40. A user may input commands to the remote controller 40 through a manual input device 42 or a microphone 43. The control unit 34 may be operable to adjust at least one actuable device element 28a-d, 32a-d, 52a, 52b in response to the commands. The adjustments of actuable device elements 28a-d, 32a-d, 52a, 52b may be measured by a sensor 58 that generates a sensor signal operable to be analyzed by the control unit 34 to determine an execution status of the command. The execution status may be indicated on the remote controller 40 by a speaker 44 or a display 45. The control unit 34 may also be operable to send signals for the remote controller 40 to make a noise.

### CROSS REFERENCE TO RELATED APPLICATIONS

The present application claims the benefit and priority of U.S. Provisional Application Ser. No. 60/912,277, filed Apr. 17, 2007, and U.S. Provisional Application Ser. No. 61/035,550, filed Mar. 11, 2008, the disclosures of which are hereby incorporated by reference in their entirety.

### FIELD OF THE INVENTION

The present invention relates to an apparatus as well as systems and methods for powering and controlling adjustable furniture, more particularly adjustable beds, using bi-directional communication.

### BACKGROUND OF THE INVENTION

Adjustable furniture, e.g., chairs, sofas and the like are well known in the art. In particular, adjustable beds are known for adjusting a user's orientation as well as the firmness/softness of the sleeping surface. For example, methods for using a fluid (i.e., liquids or gases) to pneumatically adjust characteristics of a bed are known in the prior art. Controlling such adjustable furniture is within the scope of the present invention, as is furniture that may be adjusted via a motor that does not use fluid to achieve the desired adjustment.

One aspect of controlling adjustable furniture generally includes power management. Power management of adjustable furniture typically involves controlling the power to actuators that adjust the furniture. However, modern adjustable furniture control units have not adjusted to encompass new and additional requirements. For example, users of adjustable furniture may desire additional devices to enhance their use of the adjustable furniture. However, the additional devices, or accessories, may require power. As such, there may be no way to configure the accessories at the location of the adjustable furniture, thereby depriving users of the aesthetics they desire.

Additional methods and devices for controlling adjustable furniture, such as remote (wired or wireless) controllers to communicate with control units, are also well known in the art. Quite often, manual controllers are needed, e.g., when the user is unable to speak or when quiet is desired such as when others are sleeping. The remote controllers of the prior art, however, do not send a command to the control unit of the device to be controlled, in this case adjustable furniture, wherein the control unit can then reply back to the remote controller with the command's execution status. These remote controllers are not configured to annunciate, or display, this information to the user. Also, control units for adjustable furniture typically accept only one type of remote. This presents a problem when a particular remote controller cannot be used in a particular environment, such as an infrared controller that may not ever be in the line of sight of the control unit of the adjustable furniture. Moreover, such adjustable furniture is not known to have the capability of programmed automation of surface orientation and/or firmness modifications for specified durations.

Normally, the control units of adjustable furniture are configured as part of the adjustable furniture. However, this configuration often imparts vibration and impact to the control unit, shortening its lifespan and increasing failure rates. Thus, the control unit must be replaced or repaired more frequently. In addition, typical adjustable furniture or control units are not configured with troubleshooting capabilities operable to display the cause of a failure or otherwise signal an alert about a condition. As such, when the adjustable furniture fails the user is normally forced to schedule a service call to repair the failure, rather than being able to diagnose or fix the problem themselves. Inasmuch, there is often no way to know which part of the adjustable furniture has failed, forcing a technician on the service call to bring as much equipment as they can. As such, there is often a waste of time and resources that is unacceptable.

Consequently, there is a need to overcome these deficiencies.

### SUMMARY OF THE INVENTION

A system and methods of controlling a piece of adjustable furniture of the type that includes an adjustable configuration parameter are provided. The system may include a remote controller operable to receive a command from a user to adjust the adjustable configuration parameter, a control unit in communication with the remote controller, wherein the control unit is operable to receive the command from the remote controller and control the adjustment of the adjustable configuration parameter in compliance with the command. The system also includes an actuable device element in electrical communication with the control unit and operable to adjust the adjustable configuration parameter, a sensor electrically connected to the actuable device element and the control unit, wherein the sensor is operable to measure the adjustment of the adjustable configuration parameter and to generate a sensor signal. The control unit is operable to receive the signal unit and determining an execution status of the command, then send the execution status to the remote controller. The remote controller, in turn, is operable to indicate the execution status of the command.

These and other advantages will be apparent in light of the following figures and detailed description.

### BRIEF DESCRIPTION OF THE DRAWINGS

The accompanying drawings, which are incorporated in and constitute a part of this specification, illustrate embodiments of the invention and, together with a general description of the invention given above and the detailed description of the embodiments given below, serve to explain the principles of the invention.

FIG. 1 is a diagrammatic illustration of a system for controlling various aspects and characteristics of at least one piece of adjustable furniture that includes a remote controller and a control unit that controls two types of actuable device elements to adjust the adjustable furniture;

FIG. 2 is a diagrammatic illustration of another embodiment of the adjustable furniture of FIG. 1 that includes a third type of actuable device element to adjust the adjustable furniture;

FIG. 3A is a diagrammatic illustration in the perspective view of a piece of adjustable furniture consistent with embodiments of the invention that is an adjustable bed with two sides, each side having three types of actuable device elements, and that includes a remote controller and a control unit that controls the actuable device elements of both sides of the adjustable furniture;

FIG. 3B is a diagrammatic illustration in the perspective view of a piece of adjustable furniture consistent with embodiments of the invention that is an adjustable bed with two sides, each side having three types of actuable device elements, and that includes a remote controller and a control unit for each side that controls the respective actuable device elements of each side of the adjustable furniture;

FIG. 4 is a diagrammatic illustration in the perspective view of the control unit of FIGS. 1-3 consistent with embodiments of the present invention;

FIG. 5 is a schematic diagrammatic illustration that shows the internal components of the control unit of FIGS. 1-4 consistent with embodiments of the present invention;

FIGS. 6A and 6B are diagrammatic illustrations in the perspective view of two embodiments of remote controllers consistent with embodiments of the present invention;

FIG. 7 is a schematic diagrammatic illustration that show the internal components of one embodiment of a remote controller consistent with embodiments of the present invention;

FIG. 8 is a flowchart illustrating a process consistent with the present invention to configure the remote controller to communicate with the control unit in a wireless manner consistent with one embodiment of the invention;

FIG. 9 is a flowchart illustrating a process consistent with the present invention to locate the remote controller;

FIG. 10 is a flowchart illustrating a process consistent with the present invention to receive interaction from a user at the remote controller, validate the interaction, and transfer that interaction to the control unit; and

FIG. 11 is a flowchart illustrating a process consistent with the present invention for the control unit to receive and process signals from the remote controller and transmit execution status of commands back to the remote controller.

### DETAILED DESCRIPTION

While the invention is amenable to various modifications and alternative forms, specifics thereof are described in detail herein. It should be understood, however, that the intention is not to limit the invention to the particular embodiments described. On the contrary, the intention is to cover all modifications, equivalents, and alternatives falling within the scope of the invention.

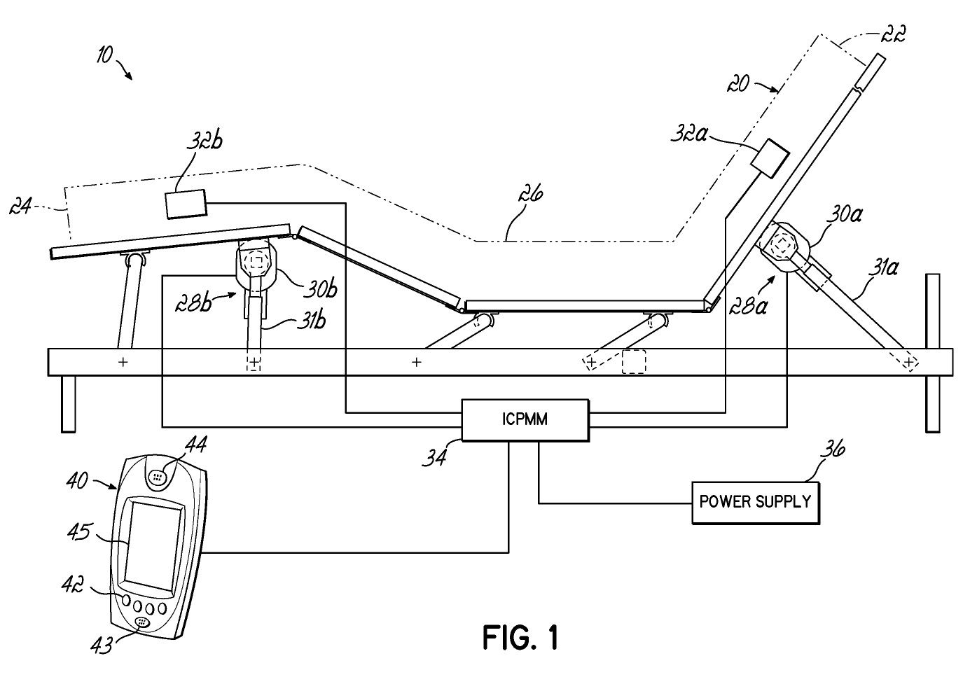

Turning to the drawings, wherein like designations denote like parts throughout the several views, FIG. 1 is a diagrammatic illustration of a system 10 for controlling various aspects and characteristics of at least one piece of adjustable furniture 20. Adjustable furniture is defined herein as furniture comprising at least one adjustable configuration parameter such as surface elevation, surface firmness, vibratory characteristics and the like, that may be adjusted. As illustrated in FIG. 1, the piece of adjustable furniture 20 may be an adjustable bed (hereinafter, “adjustable bed 20”). The adjustable bed 20 comprises a head 22, a foot 24, and a surface 26 (i.e., portions of, and the top of, a mattress) for the user to occupy. The adjustable bed 20 is operable to adjust (i.e., articulate) such that the head 22 and/or foot 24 may be raised and/or lowered as is well known in the art to suit the user's preferences and/or to provide therapeutic benefits. One having ordinary skill in the art will appreciate that the adjustable bed 20 in FIG. 1 is merely illustrative and not meant to limit the present invention to particular pieces of adjustable furniture.

The head 22 and/or foot 24 of the adjustable bed 20 may be adjusted by way of actuable device elements, such as motorized means and/or air pressure means, both of which are well known in the art. For example, and as illustrated in FIG. 1, two elevation units 28a and 28b are configured to adjust the elevation of at least a portion of the surface 26 (i.e., head 22, foot 24, and/or other surface) of the adjustable bed 20. As illustrated in FIG. 1, the first elevation unit 28a is positioned near the head 22 of the adjustable bed 20 and the second elevation unit 28b is positioned near the foot 24 of the adjustable bed 20. In a typical embodiment, each elevation unit 28a, 28b comprises an elevation unit motor 30a, 30b operatively coupled with a linear actuator 31a, 31b, respectively. Each linear actuator 31a or 31b converts the rotary motion of the corresponding elevation unit motor 30a or 30b into linear displacement, thereby adjusting the elevation of the portion of the surface 26 of the adjustable bed 20. In alternate embodiments, one having ordinary skill in the art will appreciate that the adjustable bed 20 of FIG. 1 may include more or fewer elevation units. For example, one adjustable bed consistent with the invention includes two elevation units for both the head 22 and foot 24. Similarly, one having ordinary skill in the art will appreciate that alternate embodiments of the elevation units 28a and 28b may include more than one elevation unit motor operatively coupled with each linear actuator, or one elevation unit motor operatively coupled with a plurality of linear actuators. One having ordinary skill in the art will further appreciate that the adjustable bed 20 of FIG. 1 is merely illustrative, and additional elevation units may be configured to adjust further areas of the head 22 (i.e., a “pillow tilt” elevation unit) and/or the foot 24 (i.e., an elevation unit to enable a greater downward slope from the knee of the user).

Another actuable device element, such as massaging units 32a and 32b, may be provided in the adjustable bed 20 to allow the user to experience relaxing massaging and/or therapeutic benefits while resting. As illustrated in FIG. 1, the massaging units 32a and 32b are configured under the surface 26 of the adjustable bed 20: one near the head 22 and one near the foot 24. In one embodiment, the massaging units 32a, 32b may include a motor coupled to an imbalanced weight. Supplying energy to the massaging units 32a, 32b causes the imbalanced weight to spin, producing a vibratory characteristic that can be transferred through the surface 26 to the user. Other embodiments of massaging units 32a, 32b (i.e., those that knead, apply compressive force, or move along an area of the user's body) are well known in art and considered within the scope of the present invention and the term, “massaging unit.” In one embodiment, massaging unit 32a or 32b, for example, may include a plurality of massaging units which may be controlled to produce a massaging pattern. In this manner, a rolling massage (i.e., vibration movement from the foot 24 to the head 22 and/or from the head 22 to the foot 24 of the adjustable bed 20) may be selected and experienced by the user. Additional patterns of massage may include circular massages, side-to-side massages, or focus on at least one particular region (i.e., the lower back, upper back, shoulders, neck, and/or areas of the legs). As will be discussed herein, such massage patterns may be preprogrammed or programmed by the user. One having ordinary skill in the art will appreciate that the present invention should not be limited to the illustrated embodiment of FIG. 1 that includes two massaging units 32a, 32b.

As shown in FIG. 1, each elevation unit 28a, 28b and massaging unit 32a, 32b is in electrical communication with a control unit, otherwise referred to as an integrated control and power management module (“ICPMM”), 34. ICPMM 34 is, in turn, in electrical communication with a power supply 36. The ICPMM 34 may draw standard 120 VAC from the power supply 36. The ICPMM 34 is configured to provide adjust to each elevation unit 28a, 28b and massaging unit 32a, 32b of the adjustable bed 20 in response to user commands. In some embodiments the ICPMM 34 may adjust an elevation unit 28a or 28b by providing forward energy to an elevation unit motor 30a or 30b such that the linear actuator 31a or 30b associated with that elevation unit motor 30a or 30b increases its linear displacement and elevates a portion of the adjustable bed 20 (i.e., head 22, foot 24, and/or other portion) associated with that elevation unit 28a or 28b, respectively. Conversely, the ICPMM 34 may decrease the elevation of the portion of the adjustable bed 20 by providing reverse energy to an elevation unit motor 30a or 30b such that linear actuator 31a or 30b associated with that elevation unit motor 30a or 30b decreases its linear displacement, thus lowering the portion of the adjustable bed 20 associated with that elevation unit 28a or 28b, respectively. In the illustrated embodiment of FIG. 1, both elevation units 28a and 28b are at their full linear displacement.

The ICPMM 34 is in communication with at least one remote controller 40 that is operable to receive commands from the user of the adjustable bed 20. As illustrated in FIG. 1, the remote controller 40 includes a manual input device 42 (i.e., a keypad, a keyboard, a plurality of buttons, a touch pad, and/or a touch screen) to receive input from the user. In some embodiments the remote controller 40 may also include a microphone 43 to pick up a voice of the user and at least one status annunciator to interact with the user. In some embodiments, the status annunciator may be a speaker 44 to play sounds and/or a display 45 (i.e., a display that includes a plurality of LEDs, an LCD display, and/or another unit capable of displaying information) operable to display information about the adjustable bed 20. In some embodiments, the display 45 is incorporated with the manual input device 42. As such, the manual input device 42 and display 45 may function in a manner similar to touch screens as is well known in the art. As illustrated in FIG. 1, however, aspects of the manual input device 42 and display 45 are separate.

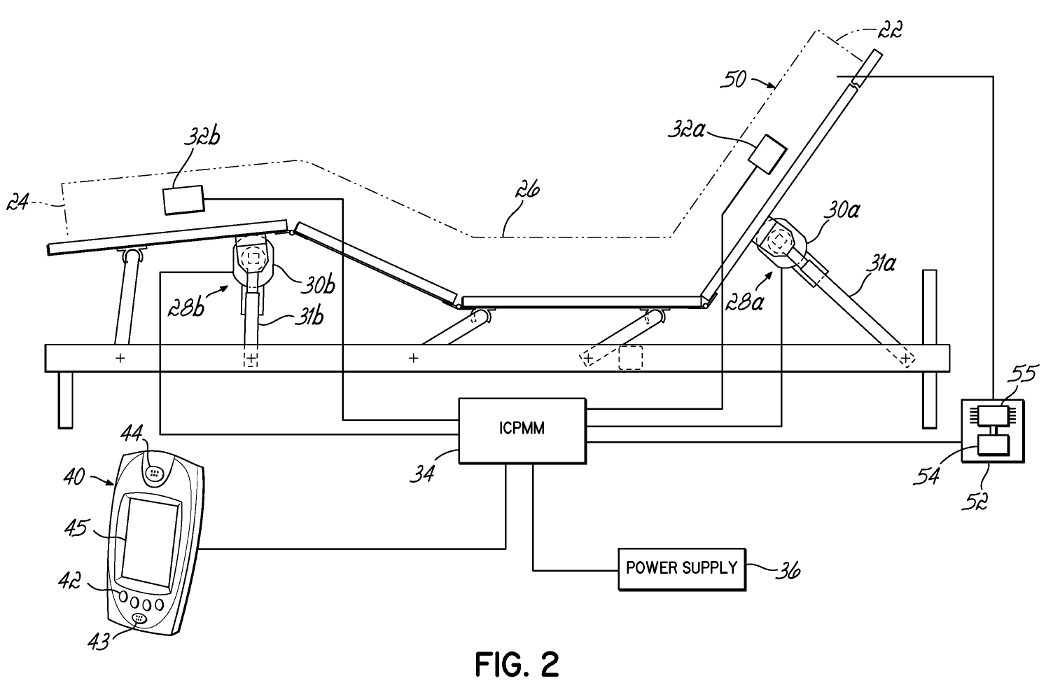

FIG. 2 is an illustration of an embodiment of an adjustable bed 50 that includes a third actuable device element, such as a pump 52, that may be used to adjust the firmness of the surface 26 of the adjustable bed 50. The pump 52 is in operative communication with the adjustable bed 20 and in electrical communication with the ICPMM 34. The pump 52 may be used in conjunction with existing fluid beds (i.e., air and/or water beds), such as those manufactured and marketed by Select Comfort Corporation, Minneapolis, Minn., to selectively inflate and/or deflate one or more internal bladders of the adjustable bed 50. Thus, the user may optimize the firmness of the entire adjustable bed 50, or two users may optimize the firmness of a portion (i.e., one of two sides) of the adjustable bed 50 to suit their preferences and/or provide therapeutic benefits. In this manner, one user may have a firmer adjustable bed 50 surface 26 while the other user may have a less firm, or softer, adjustable bed 50 surface 26. Moreover, the adjustable bed 50 surface 26 may be divided into zones corresponding to the user's body and associated pressure points, wherein the firmness may be manipulated on a zone by zone basis.

In one embodiment, the pump 52 comprises a pump motor 54 and a compressor 55. The compressor 55 may convert the rotary motion of the pump motor 54 into compressive force on a fluid (i.e., a gas or a liquid) when the pump motor 54 is engaged, thereby adjusting the firmness of the surface 26 of the adjustable bed 50. The ICPMM 34 may adjust the firmness through various control signals such that a control signal on one or more pump control lines may cause the pump 52 to increase the pressure in the internal bladder, thus increasing the firmness of the surface 26 of the adjustable bed 50. Similarly, another control signal on the one or more pump control lines may cause the pump 52 to decrease the pressure in the internal bladder, thus decreasing the firmness of the surface 26 of the adjustable bed 50. In this way, a user may control, via the remote controller 40, the firmness of the surface 26 of adjustable bed 50. As shown in FIG. 2, the adjustable bed 50 is also configured with first and second elevation units 28a and 28b and massaging units 32a, 32b. Thus, the surface orientation, surface firmness, and/or massage profile (i.e., the configuration of the massagers operating, or the vibratory characteristics of one embodiment of the massaging units 32a, 32b) of the adjustable bed 50 may be adjusted.

As illustrated in FIG. 1 and FIG. 2, the adjustable beds 20 and 50 are primarily designed for one person (i.e., twin bed, twin extra large bed, double bed, etc.) that use two elevation units 28a and 28b, two massaging units 32a, 32b, and, in the case of adjustable bed 50, one pump 52. Thus, there is one remote controller shown 40. It will be appreciated by one having ordinary skill in the art that, in some embodiments, adjustable beds are primarily designed for more than one person (i.e., queen bed, standard king bed, California king bed, etc.) where it may be preferred that each side have separate elevation units, massaging units, and/or pumps. In those embodiments, it may be preferred that each side have separate remote controllers 40 such that the sides are independently controllable.

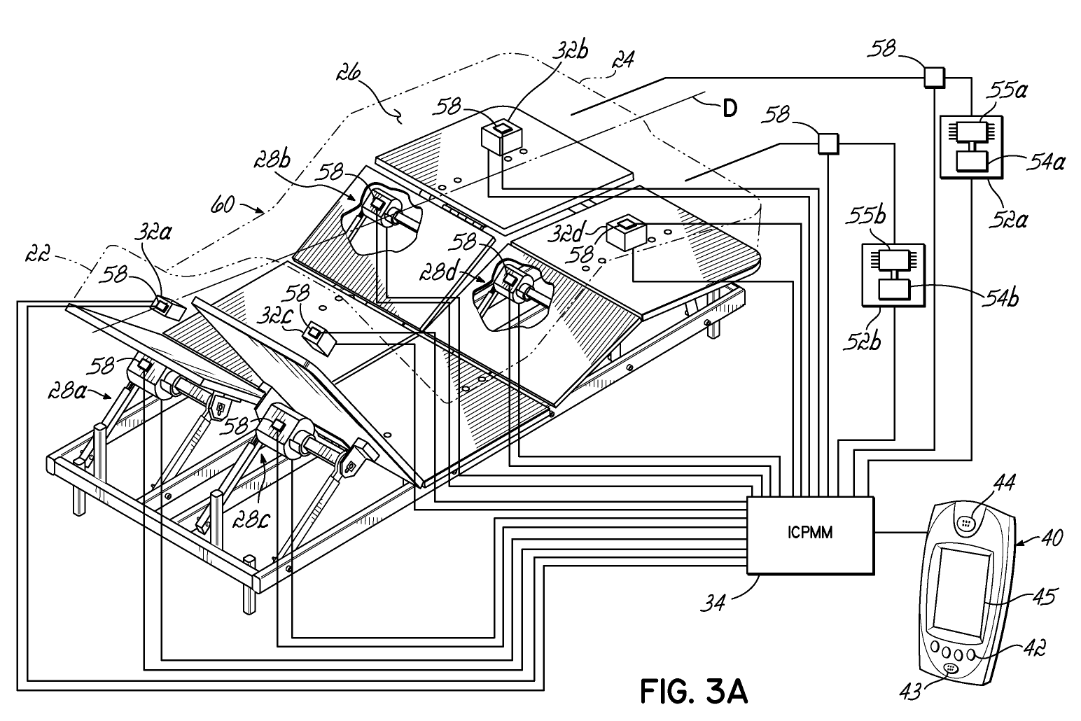

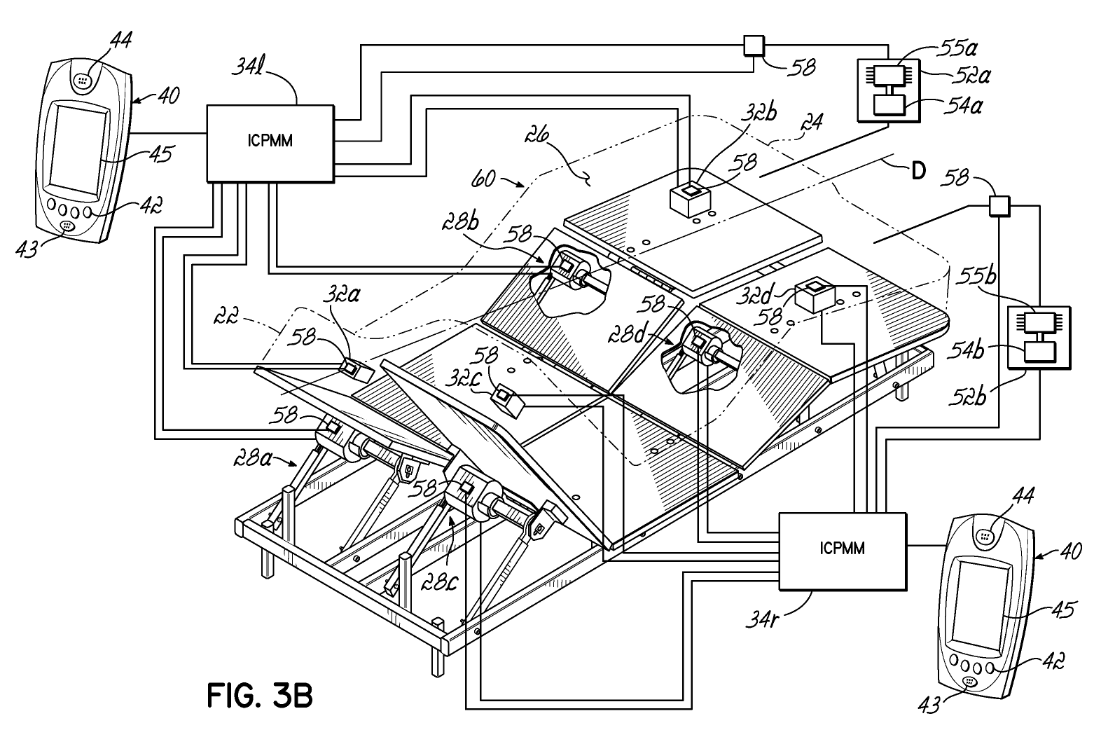

FIG. 3A illustrates a prospective view of the sides of an adjustable bed 60 consistent with embodiments of the invention. The adjustable bed 60, as discussed above, may be configured with sides that include separate elevation units 28a, 28b, 28c, and 28d, massaging units 32a, 32b, 32c, 32d, and pumps 52a and 52b such that the adjustable bed 60 may be independently controlled on a left side and a right side. Thus, the elevation (i.e., the configuration of the elevation units 28a-d), firmness (i.e., configuration of the firmness of the adjustable bed to surface 26), and/or massage profile (i.e., the operating configuration of the massaging units 32a-d, or the vibratory characteristics of one embodiment of the massaging units 32a-d) of the left and right sides of the adjustable bed 60 may be individually controlled using separate remote controllers 40 communicably coupled to one or more ICPMM 34. In the embodiment of FIG. 3A, the adjustable bed 60 includes one ICPMM 34 and one remote controller 40.

As illustrated in FIG. 3A, each elevation unit 28a-d, massaging unit 32a-d, and pump 52a, 52b (collectively, “actuable device elements”) and the ICPMM 34 are in electrical communication with an actuable device sensor, or “sensor,” 58. The sensors 58 may be operable to measure the energy to each actuable device element. The sensors 58 may also be operable to measure the adjustment of each of the actuable device elements and generate a signal that corresponds to this measurement. In this way, the ICPMM 34 may determine an execution status of each adjustment, as well as indicate whether there is acceptable energy to each actuable device element. Also in this way, the ICPMM 34 may be able to determine and indicate whether each actuable device element is operating correctly or has completed the adjustment. As shown in FIG. 3A, the sensors 58 are configured on each actuable device element. However, one having ordinary skill in the art will appreciate that the placement of the sensors 58 is exemplary, and in other embodiments the sensors 58 may be configured on the adjustable bed 60, the adjustable bed 60 support structure, or on the floor.

The sensors 58, in one embodiment, are operable to observe, measure, and collect data regarding the change of orientation, elevation, and/or firmness produced by the actuable device elements in response to a command. This data may be subsequently communicated to the remote controller or user. For example, and in one specific embodiment, those having ordinary skill in the art will recognize that the linear position and displacement of elevation units 28a-d may be monitored and/or measured using at least one electromechanical linear position and displacement sensor such as a resistive, capacitive, inductive, magnetic, and/or pulse encoding sensor. Such sensors may be capable of observing linear position and displacement, and measure incremental changes that occur in these parameters. Furthermore, vibration sensors, such as accelerometers, are also well known in the art and may be used to determine whether the command to increase and/or decrease the vibratory characteristics of massaging units 32a-d has been successful, or whether the command has failed. Similarly, pressure sensors are well known in the art and may be used to determine whether the command to increase and/or decrease the firmness of the surface 20 of the adjustable bed has been successful, or whether the command has failed. Such pressure sensors may also be configured to monitor and measure the pressure from the pumps 52a, 52b on an incremental basis.

For example, and in one specific embodiment, with reference to FIG. 3A, one or more sensors 58 may be mounted on the adjustable furniture and/or each elevation unit 28a-d for monitoring and/or measuring the linear displacement and/or position of certain portions of the adjustable bed 60, and may further be in electrical communication with the ICPMM 34. Sensor signals may then be communicated to the ICPMM 34 and compared with data stored in the ICPMM 34 that includes expected values. Thus, the sensor data may be evaluated by the ICPMM 34 to determine whether the execution status of the command entered. The execution status may indicate whether the command was successful or whether the command failed. The ICPMM 34 may then indicate this execution status on the remote controller 40.

With continued reference to FIG. 3A, the remote controller 40 may receive interaction (i.e., commands) from the user through the manual input device 42 and/or microphone 43 then relay those commands to the ICPMM 34. The remote controller 40 may also receive information from the ICPMM 34 and relay that information to the user through the speaker 44 and/or display 45. Information sent to the ICPMM 34 may include commands that indicate a desired elevation, firmness, and/or massaging profile. For example, the information may specify that a user wants a gentle massage, with five percent head elevation, followed an hour later by no massage and zero percent head elevation (i.e., the head 22 is flat). Similarly, the user may program a desired firmness for a desired time.

The microphone 43 on the remote controller 40 is configured to detect the voice of the user. In one embodiment, the microphone 43 is configured to convert sounds into electrical signals, then the remote controller 40 is configured convert those electrical signals into machine readable data (i.e., commands). These commands are then transferred to the ICPMM 34. In another embodiment, the microphone 43 is configured to convert sounds into electrical signals, then the remote controller 40 is configured to transmit those electrical signals to the ICPMM 34. In that embodiment, the ICPMM 34 converts the electrical signals into machine readable data. In some embodiments, after receiving a command, the ICPMM 34 acts to fulfill the command, determines the execution of the command (i.e., whether it was fulfilled, or how the command affect an adjustable bed component), and transmits information and/or the execution status to the remote controller 40 to indicate (i.e., play on the speaker 44 or provide on the display 45) the status of the adjustable bed to the user. For example, and in a specific embodiment, the information may include sounds indicating whether the last command received was understood (i.e., separate tones for success and failure may be provided), the execution status of a command, and/or the last command spoken by the user into the microphone 43 that was processed by the ICPMM 34.

The information relayed to the user through the remote controller 40, and more specifically, either through the speaker 44 or display 45, may include the current orientation (i.e., surface 26 elevations) of the adjustable bed, the current vibratory characteristics of the adjustable bed, the current firmness of the adjustable bed, whether a routine has been selected, or other information about the adjustable bed (i.e., the adjustable beds 20, 50, and 60 of FIGS. 1-3). The information may be provided on the display 45 with a user interface that allows the user to input commands, and/or select preprogrammed routines or sequences, including durations of specific sequences. The information may further include status information, the amount of time left in the present routine, the next stage of a routine, and/or the execution status of the last command. For example, the information may indicate that fifteen minutes of vibrating massage to the upper back remains, followed by raising the head 22 of the adjustable bed 20 five inches for a period of twenty minutes.

In this way, the remote controller 40 is operative to interact with the ICPMM 34 to command the ICPMM 34 as well as create and select routines for adjusting the adjustable bed. For example and without limitation, a user may wish to fall asleep on the adjustable bed while lying relatively flat, at a designed firmness of sleeping surface, and with a mild vibration profile. Prior to falling asleep, the user may program the ICPMM 34 to stop the massaging profile in one hour. The user may further desire to wake up at a certain time with the head 22 raised to a desired level and with an increase in surface firmness. Thus the user interacts with the remote controller 40 and programs a routine for the ICPMM 34 to execute and perform the desired actions by programming the time and date to wake up and the level of elevation change. The ICPMM 34 executes the routine accordingly.

For users that are fully or partially bedridden, routines may provide a level of automation that assist in the prevention of bed sores or assist in therapy. In addition, users with respiratory difficulties, circulatory conditions, and other maladies may benefit therapeutically from the present invention. Particularly, changing the orientation, firmness and vibratory characteristics of the bed periodically and/or on a programmed basis would be desirable in assisting in the treatment of users. For example, the head 22 and/or foot 24 orientation may be modified at fixed intervals, such as every two hours. In addition, the massaging units may be turned on and off with increasing and/or decreasing levels of massaging power as desired. Additionally, massaging patterns may be selected and changed periodically. Moreover, the surface firmness may be modified periodically.

FIG. 3B illustrates a prospective view of the sides of an adjustable bed 60 consistent with embodiments of the invention having two ICPMMs 34l and 34r (i.e., one ICPMM 34l controls the left side of the adjustable bed 60, and one ICPMM 34r controls the right side of the adjustable bed 60), and two remote controllers 40. The adjustable bed 60, as discussed above, may be configured with sides that include separate elevation units 28a, 28b, 28c, and 28d, massaging units 32a, 32b, 32c, 32d, and pumps 52a and 52b such that the adjustable bed 60 may be independently controlled on a left side and a right side. Thus, the elevation (i.e., the configuration of the elevation units 28a-d), firmness (i.e., configuration of the firmness of the adjustable bed to surface 26), and/or massage profile (i.e., the operating configuration of the massaging units 32a-d, or the vibratory characteristics of one embodiment of the massaging units 32a-d) of the left and right sides of the adjustable bed 60 may be individually controlled using the separate remote controllers 40. As illustrated in FIG. 3B, each actuable device element and the ICPMMs 34l and 34r are in electrical communication with an actuable device sensor 58 to measure the energy to each actuable device element or to measure the adjustment of each of the actuable device elements and generate a signal that corresponds to this measurement. In this way, the ICPMMs 34l may determine an execution status of each adjustment for the left side, as well as indicate whether there is acceptable energy to each actuable device element on the left side. Also in this way, the ICPMM 34r may be able to determine and indicate whether each actuable device element is operating correctly or has completed the adjustment on the right side. As shown in FIG. 3B, the sensors 58 are configured on each actuable device element. The ICPMMs 34l and 34r are configured to avoid cross-talk, or other interference, between either the ICPMMs 34l and 34r or the remote controllers 40. For example, the ICPMMs 34l and 34r are configured to be associated with one or more remote controllers 40. After configuration, the ICPMMs 34l and 34r will only accept commands from those remote controllers configured to that ICPMM 34l or 34r. In this way, the ICPMMs 34l and 34r are configured to avoid the cross-talk and interference that is not avoided by the prior art.

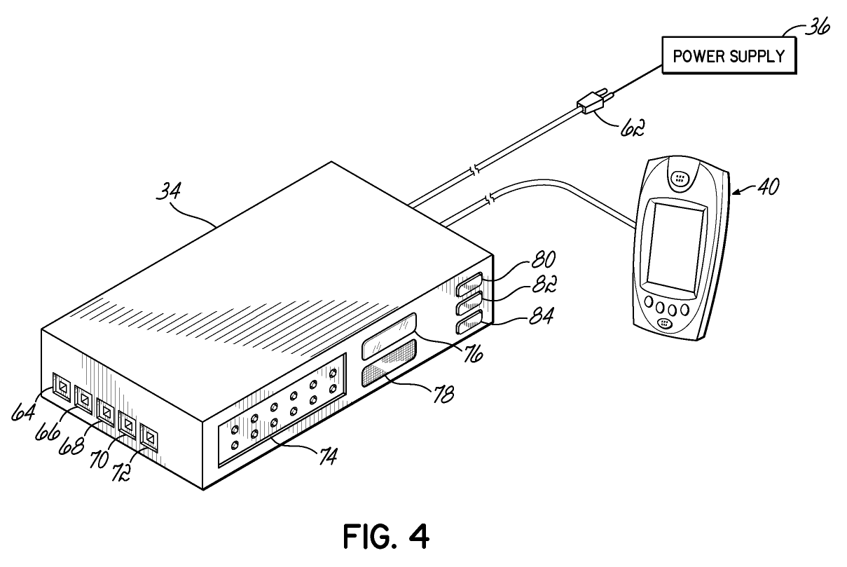

FIG. 4 is a perspective view of the ICPMM 34 consistent with the present invention that illustrates various aspects of the ICPMM 34. As shown in FIG. 4, the ICPMM 34 is a separate unit from the adjustable bed that may sit on a surface (i.e., such as the floor, a table, or other substantially planar surface) and draw energy from the power supply 36 through a power cord 62. In this way, the ICPMM 34 is not subjected to the rigors of control units of the prior art that are configured as part of adjustable furniture.

The ICPMM 34 draws 120 VAC energy from the power supply 36, which may be a standard electrical outlet, and powers and adjusts the elevation units 28a-d, massaging units 32a-d, pumps 52a, 52b, and/or accessories (i.e., collectively, “actuable device elements”) connected to the adjustable bed. The ICPMM 34 may be easily replaced in the event of failure by disconnecting it from the actuable device elements, the power cord 62, and/or the remote controller 40, and removing it. To prevent damage to the ICPMM 34, the ICPMM 34 is configured to monitor the power from the power supply 36 and quickly save data and shut down in the event of a power failure.

The ICPMM 34 may include one or more control ports 64-70 configured to provide power, and control the operation of, actuable device elements. For example, the ICPMM 34 includes the control port 64, which may be a control port for at least one elevation unit. At least one elevation unit is in electrical communication with the ICPMM 34 through the control port 64. In this way, each elevation unit may be individually powered and adjusted by the ICPMM 34. Similarly, the ICPMM 34 may include the control port 66, which may be a control port for at least one massaging unit. Additionally, the ICPMM 34 may include the control port 68, which may be a control port for at least one pump. Finally, the ICPMM 34 may include the control port 70, which may be a control port for at least one accessory. In some embodiments, the control port 70 may provide power for at least one accessory. For example, one accessory may be a lamp that can be placed on a table or that is in electrical communication with ICPMM 34. In this way, the ICPMM 34 adjusts the energy to the control port 70 to control the accessory.

Each control port 64-70 may be configured to accept a quick-connect plug such that each at least one actuable device element and/or accessory may be quickly changed in the event of its, or the ICPMM's 34, failure. It will be appreciated by one having ordinary skill in the art that each actuable device element and/or accessory may draw power through its respective control port, and that multiple actuable device elements and/or accesories of the same type may be in electrical communication with the ICPMM 34 through one port. As such, the ICPMM 34 may include sufficient electrical couplings to power and control multiple actuable device elements per control port 64-68 and multiple accessories per control port 70.

In some embodiments, the ICPMM 34 may include a port 72, which may be a port for at least one sensor signal. As such, at least one sensor 58 may be in electrical communication with the ICPMM 34 through the port 72. It will be appreciated by one having ordinary skill in the art that the sensors 58 may communicate through control ports 64-70 rather than port 72.

One having ordinary skill in the art will appreciate that an ICPMM 34 may omit one or more of the control ports 64-70 or the port 72, yet still be within the scope of the present invention. Furthermore, one of ordinary skill in the art will appreciate that a plurality of each of the actuable device elements and/or accessories may be controlled through respective control ports 64-70. Additionally, though FIG. 4 illustrates four control ports 64-70, alternate embodiments may include more or fewer control ports. Similarly, though FIG. 4 illustrates one port 72, alternate embodiments may include more ports that may be ports for at least one sensor 58.

The ICPMM 34 may include a status indicator 74, which, in one embodiment, may be comprised of a plurality of LEDs (i.e., single color or multi-color LEDs) that indicate the status of the actuable device elements, status of the ICPMM 34 itself, status of the accessories, and/or status of the adjustable bed. In this way, a green LED may indicate a nominal, or normal condition, while a yellow or red LED may indicate a failure. In this embodiment, the LEDs comprising the status indicator 74 may indicate whether there is acceptable energy from the power supply 36, whether signals from the remote controller 40 have been received and understood, whether there is acceptable energy to each actuable device element (i.e., one or more LEDs configured to show the power status of each elevation unit 28a-d, massaging unit 32a-d, and pump 52a, 52b), whether the actuable device elements of the adjustable bed are operating correctly (i.e., one or more LEDs configured to show the operational status of the actuable device elements), and whether there is acceptable energy to one or more accessory. The status indicator 74 may provide the user the capability to quickly troubleshoot failures of components of the adjustable bed. It will be appreciated by one having ordinary skill in the art that the status indicator 74, in alternate embodiments, may comprise a video display, LCD, or other display such that information about the actuable device elements, ICPMM 34, accessories, and/or adjustable bed may be displayed by the ICPMM 34.

The ICPMM 34 may include a light 76 to provide illumination for the user. The light 76 may be configured to provide illumination for the user in response to a command received at the remote controller 40. Although only one light 76 is shown in FIG. 4, alternate embodiments the ICPMM may be configured with multiple lights to provide illumination. For example, in a specific embodiment, the ICPMM 34 may be configured with two lights 76 such that one provides illumination for one side of the adjustable bed, and the other provides illumination for the other side of the adjustable bed. In that embodiment, each light 76 may be controlled by separate remote controllers 40.

As shown in FIG. 4, the ICPMM 34 may be in electrical communication with the remote controller 40 through a remote controller port. The cord coupling the remote controller 40 to the ICPMM 34 may be removeable from both the remote controller 40 and ICPMM 34. In some embodiments, the ICPMM 34 may include two remote controller ports to communicate with two remote controllers 40. For example, one user may connect a remote controller 40 into one remote controller port to control the right side of an adjustable bed, while another may plug in a remote controller 40 into another remote controller port to control the left side of the adjustable bed.

The ICPMM 34 may also be in communication with the remote controller 40 wirelessly through an infrared (“IR”) port 78 and/or by way of radio frequency communication. By communicating wirelessly, the user is provided freedom of movement with the remote controller 40.

The ICPMM 34 may include a plurality of buttons to enable the user to interact directly with the ICPMM 34. As illustrated in FIG. 4, the ICPMM 34 is configured with three buttons: a power button 80, a remote controller configuration button (“RCC button”) 82, and a remote controller location button (“RCL button”) 84. When the user presses and holds the power button 80, or when the ICPMM 34 detects a failure of the power supply 36, the ICPMM 34 saves the bed's position information, firmness, vibratory profile, and/or currently operating routine. Then, the ICPMM 34 shuts down to conserve energy, and waits for the power button 80 to be depressed again. The RCC button 82 is utilized to associate remote controllers 40 with the ICPMM 34. To associate one remote controller 40 with the adjustable bed, the user presses the RCC button 82 on the ICPMM 34 and then presses a combination of buttons, or touches particular areas, on the remote controller 40 within a short time period. The ICPMM 34 detects the signal from the remote controller 40 and associates that remote controller with the adjustable bed. When the adjustable bed is configured with two sides, the first remote controller 40 associated with the adjustable bed is associated with the left side. The user may repeat the process to associate a second remote controller 40 with the right side. Remote controllers 40 in electrical communication with the ICPMM 34 through a cord do not have to be associated with the ICPMM 34.

To locate one or more remote controllers 40 associated with the adjustable bed, the user may press the RCL button 84. This induces the ICPMM 34 to send out a signal (i.e., through the cord connecting the one or more remote controllers 40 to the ICPMM 34, through the IR port 78, and/or through radio frequency communication) to induce the one or more remote controllers 40 associated with the adjustable bed to make a noise on their speakers 44, such as a beeping noise. Thus, the user may locate the one or more remote controllers 40 by tracking sounds from their speakers 44.

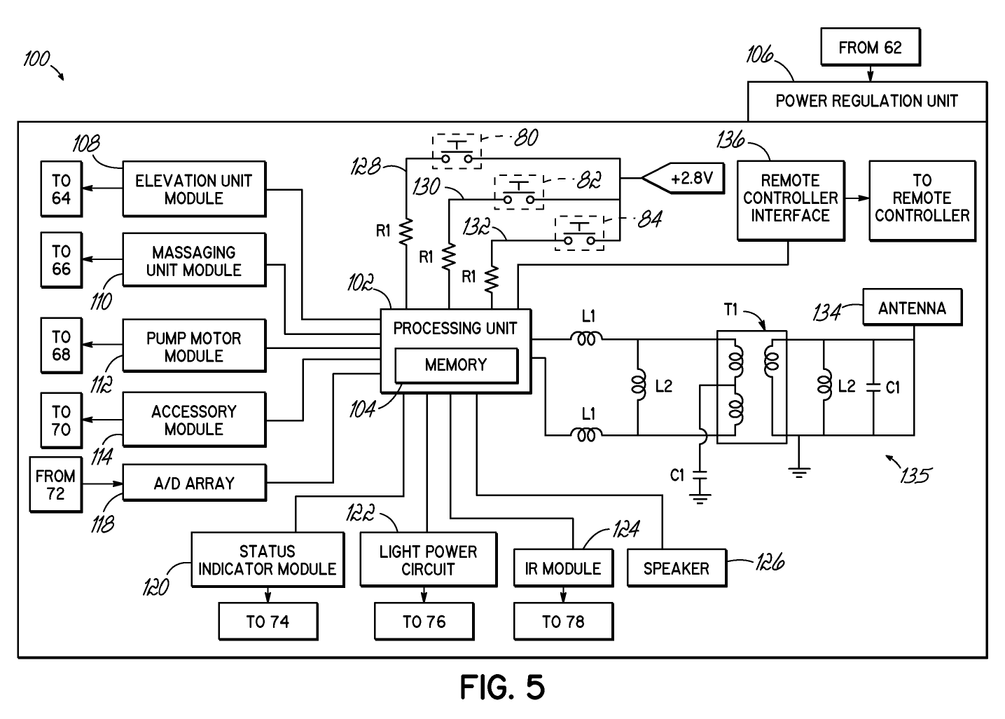

FIG. 5 is a schematic diagrammatical illustration 100 that generally illustrates components of one embodiment of the ICPMM 34 consistent with the present invention. The processing capabilities of the ICPMM 34 are handled by a processing unit 102 that may include a memory 104. The processing unit 102 can be one or more processors, controllers, or field programmable gate arrays, while memory 104 can be random access memory devices, cache memories, non-volatile memories, and/or read-only memories. Memory 104 can additionally be part of the processing unit 102 or located elsewhere in the ICPMM 34. In one embodiment, processing unit 102 includes one microcontroller, such as a MC13211 series microcontroller produced by Freescale Semiconductor of Austin, Tex., in electrical communication with a second microcontroller, such as a MC13212 series microcontroller also produced by Freescale Semiconductor of Austin, Tex. The two MC1321x series of microcontrollers incorporate a low power 2.4 gigahertz (“GHz”) radio frequency transceiver operable to communicate by way of the Institute of Electrical and Electronics Engineers (“IEEE”) 802.15.4 low-rate wireless personal area network standard with an 8-bit microcontroller. By utilizing the 2.4 GHz radio frequency, the ICPMM 34 and remote controller 40 advantageously avoid household interference from a variety of devices, such as garage door openers, wireless computer networks, radio controlled toys, and other devices that communicate through RF frequencies. As such, the processing unit 102 may be operative to communicate wirelessly with a remote controller 40 and control adjustable bed components.

The memory 104 may include data that includes the relative expected values for surface orientation, massage profiles, and surface firmness. Thus, sensor data may be used to communicate, and the memory 104 may be operable to store, the elevation of portions of the adjustable bed, the massaging profile currently engaged, as well as the relative firmness. For example, the ICPMM 34 may determine and store data indicating that the foot section on the left side of the bed is raised 25%, the left head section is flat and the firmness on the left side of the bed is, e.g., at pressure number 45 or perhaps at pressure 65%, and/or the current massage profile.

Additionally, the memory 104 allows storage, access, and execution of programmed routines, such as routines created and programmed by the user, routines for surface orientation, routines for surface firmness, and/or routines for vibratory and massaging preferences. Mechanisms and methods for programming routines which are stored and executed upon command are well known in the art. The memory 104 may also store the adjustable bed's current adjustable configuration parameters, such as the elevation, the surface 26 firmness, and the massage profiles of the adjustable bed. Thus, the user may access, and determine, the current adjustable configuration parameters through the remote controller. The remote controller may annunciate the parameters through the speaker 44 or display 45.

As shown in FIG. 5, the ICPMM 34 includes a power regulation unit 106 electrically coupled with the ICPMM 34 to convert the 120 VAC received from the power supply 36 into various direct current voltage outputs. In particular, the power regulation unit 106 may include at least one auto transformer and circuitry to convert the 120 VAC input into output voltages that correspond to substantially +2.8 VDC (for example, to power the sensors 58, processing unit 102, and memory 104), +12 VDC (for example, to power the pump 52 and the light 76), and +24 VDC (for example, to power elevation units, massaging units 32, and accessories). Additionally, the power regulation unit 106 may convert an alternating current input voltage (i.e., such as 120 VAC) into additional DC voltages as required by the ICPMM 34 and/or actuable device elements. The power regulation unit 106 may further include a power storage device, such as a super-capacitor, that is operable to provide a source of temporary DC energy to power the ICPMM 34 for a short period of time. This period of time is configured to be a suitable amount of time to store actuable device element characteristics, routines, and sensor data, and other data in memory 104.

The ICPMM 34 may include at least one elevation unit module 108, massaging unit module 110, pump module 112, and/or accessory module 114. The processing unit 102 may use the elevation unit module 108, which may comprise a motor driver, to provide energy to at least one elevation unit. In this way, the processing unit 102 may control at least one elevation unit to raise and/or lower the elevation of a portion of the surface 26 of the adjustable bed through the elevation unit module 108. In one embodiment, each elevation unit module 108 includes an full-bridge motor driver to provide energy to one elevation unit, such as a VNH3SP30 full-bridge motor driver produced by STMicroelectronics of Carrollton, Tex. In alternate embodiments, each elevation unit module 108 includes two full-bridge motor drivers to provide energy to two elevation units.

To raise the elevation of a portion of the surface 26, the processing unit 102 sends a signal to the elevation unit module 108 to output forward energy. The elevation unit module 108 may then output a forward voltage to at least one elevation unit, increasing the elevation of a portion of the surface 26 of the adjustable bed. Similarly, to lower the elevation of a portion of the surface 26, the processing unit 102 sends a signal to the elevation unit module 108 to output reverse energy. In that embodiment, the elevation unit module 108 may then output a reverse voltage to at least one elevation unit, decreasing the elevation of a portion of the surface 26 of the adjustable bed. The elevation unit module 108 may be in electrical communication with the at least one elevation unit through the control port 64 of FIG. 4.

With continued reference to FIG. 5, the processing unit 102 may use the massaging unit module 110 to power and control at least one massaging unit 32. In one embodiment, processing unit 102 may control one massaging unit 32 through the massaging unit module 110. In alternate embodiments, the massaging unit module 110 may be configured to adjust the power to a plurality of massaging units 32a-d. In one embodiment, by adjusting the energy supplied through the massaging unit module 110 to the massaging units 32a-d, the ICPMM adjusts the intensity of the vibration of the massaging units 32a-d. For example, the higher the voltage supplied to at least one massaging unit 32a-d from the massaging unit module 110, the faster the massaging unit motor rotates, and the more vigorous the vibratory sensation. Although FIG. 5 illustrates one massaging unit module 110, other embodiments of the MPCC 34 consistent with the present invention may include more than one massaging unit module 110. For example, two massaging unit modules 110 may be configured to control the massaging units 32a-b of adjustable beds 20, 50 of FIGS. 1 and 2, while four massaging unit modules 110 may be configured to control the massaging units 32a-d adjustable bed 60 of FIG. 3A. The massaging unit module 110 may be in electrical communication with at least one massaging unit 32a-d through the port 66 of FIG. 4.

The processing unit 102 may use the pump module 112 to control at least one pump 52. In one embodiment, the pump module 112 may control the pump 52 through one or more control lines. When a first control signal on the one or more control lines is active, the pump 52 increases the pressure of an internal bladder beneath the surface 26 of the adjustable bed. When a second control signal on the one or more control lines is active, the pump 52 decreases the pressure of the internal bladder beneath the surface 26 of the adjustable bed. Although FIG. 5 illustrates one pump module 112, other embodiments of the ICPMM 34 consistent with the present invention may include more than one pump module 112. For example, two pump modules 112 may be configured for the adjustable bed 60 of FIG. 3A. The pump module 112 may be in electrical communication with the pump 52 through the port 68 of FIG. 4. In one embodiment, each pump 52 draws power from the power regulation unit 106, but is controlled by the ICPMM 34 through the pump module 112. In alternate embodiments, each pump 52 draws power and is controlled by the ICPMM 34 through the pump module 112.

The processing unit 102 may control one or more accessories through the accessories module 114. Each accessory module 114 may supply energy to one or more accessories and include an accessory control line that may be operable to control the one or more accessories. In one embodiment, the accessory control line instructs the one or more accessories to turn off. Although FIG. 5 illustrates one accessory control module 114, other embodiments of the ICPMM 34 consistent with the present invention may include more than one accessory control module 114. The accessory control module 114 may be in electrical communication with the accessories through the control port 70 of FIG. 4.

The processing unit 102 receives signals from the sensors 58 through the port 72 of FIG. 4. The sensor signals are converted from analog to digital values in an analog to digital array (“A/D array”) 118. Thus, the processing unit 102 may receive sensor inputs and monitor the power to the actuable device elements. The processing unit 102 may also receive sensor inputs and monitor the operational characteristics of each of the actuable device elements. In this way, the processing unit 102 may determine whether there is acceptable power from the power supply 36, whether there is acceptable power to each actuable device element, whether each actuable device element is operating correctly, general faults of the adjustable bed, ICPMM 34, or actuable device elements, and the execution status of commands.

Returning to FIG. 5, the ICPMM 34 includes a status indicator module 120 in electrical communication and operable to control the status indicator 74. In one embodiment, the status indicator module 120 is operable to drive the plurality of LEDs that comprise the status indicator 74 in a manner well known in the art. In alternate embodiments, the status indicator module 120 may be operable to control an LCD or other visual display. The processing unit 102 is configured to selectively control the status indicator module 120 to display selective information on the status indicator 74.

The ICPMM 34 may further include a light power circuit 122 to selectively energize the light 76 in response to a signal from the processing unit 102. Such power circuits as that for the light power circuit 122 are well known in the art.

The ICPMM 34 may include an IR module 124 operable to interface with the IR port 78 and communicate bi-directionally with the remote controller 40 in a manner that conforms with the standards published by the Infrared Data Association (or “IRDA standard”) and/or in a manner that conforms with the Classical Infrared standard (“CIR standard”) as is well known in the art. As such, the ICPMM 34 is configured to communicate wirelessly with the remote controller 40. The ICPMM 34 may further include an ICPMM speaker 126 to produce sounds. The ICPMM speaker 126 may be used to produce a sound corresponding to a power loss, error condition, acknowledgment, or that the limit for an elevation unit 28 has been reached.

The processing unit 102 receives signals from the power button 80, RCC button 82, and RCL button 84 through signal lines 128, 130, and 132, respectively. In one embodiment, the buttons 80, 82, and 84 are pushbuttons that close a circuit and provide a logic high on signal lines 128, 130, and 132, respectively, when depressed. The processing unit 102 is configured to monitor the signal lines 128, 130, and 132 to determine when they have reached a logic high state. The processing unit 102 then reacts accordingly. In one embodiment, the processing unit 102 begins power down procedures in response to a logic high on signal line 128. In one embodiment, the processing unit 102 initiates a remote control configuration sequence in response to a logic high on signal line 130. And, in one embodiment, the processing unit initiates a remote control location sequence in response to a logical high on signal line 132. To provide a sufficiently stable logic high, a resister R1 acts as a pull-up resistor on signal lines 128, 130, and 132.

As illustrated in FIG. 5, the processing unit 102 may be in electrical communication with a radio-frequency antenna (“antenna”) 134 through a circuit arrangement 135. The antenna 134 is configured to receive wireless radio frequency signals from the remote controller 40. Similarly, the antenna 134 is configured to transmit wireless frequency signals to the remote controller 40. In this way, the antenna 134 is configured to operate as an ICPMM RF transceiver. As disclosed above, the processing unit 102 may comprise one or more microcontrollers that, in one embodiment, include a low power 2.4 GHz radio frequency transceiver operable to communicate by way of the IEEE 802.15.4 low-rate wireless personal area network standard. As illustrated in FIG. 5, the circuit arrangement 135 may include two inductors L1 connected in parallel and bridged by a third inductor L2. That circuit is further connected to a balun transformer T1. A capacitor C1 interrupts one side of the balun transformer T1 and leads to ground. Coupled to the antenna 134 are a capacitor C1 and inductor L2 in parallel, that circuit further in parallel with the balun transformer T1. The inductors L1 and L2 may be about 1.5 nH and 3.9 nH, respectively, while the capacitors C1 may be about 10 pF. As such, the processing unit 102 may communicate bi-directionally with the remote controller 40 through the antenna 134. One having skill in the art will appreciate that these values are merely illustrative, and other inductor and capacitor values may be substituted without departing from the scope of the invention.

The remote controller 40 and ICPMM 34 may communicate wirelessly and bi-directionally through infrared communications (i.e., through the IR port 78 and IR module 124) and radio-frequency communications (i.e., through antenna 134 and circuit arrangement 135). However, the remote controller 40 may also be directly connected to the ICPMM 34 as shown in FIG. 4. The ICPMM 34 may include a remote controller interface 136 that provides power to the remote controller 40, receives data from the remote controller 40, and sends data to the remote controller 40 when it is directly connected to the ICPMM 34.

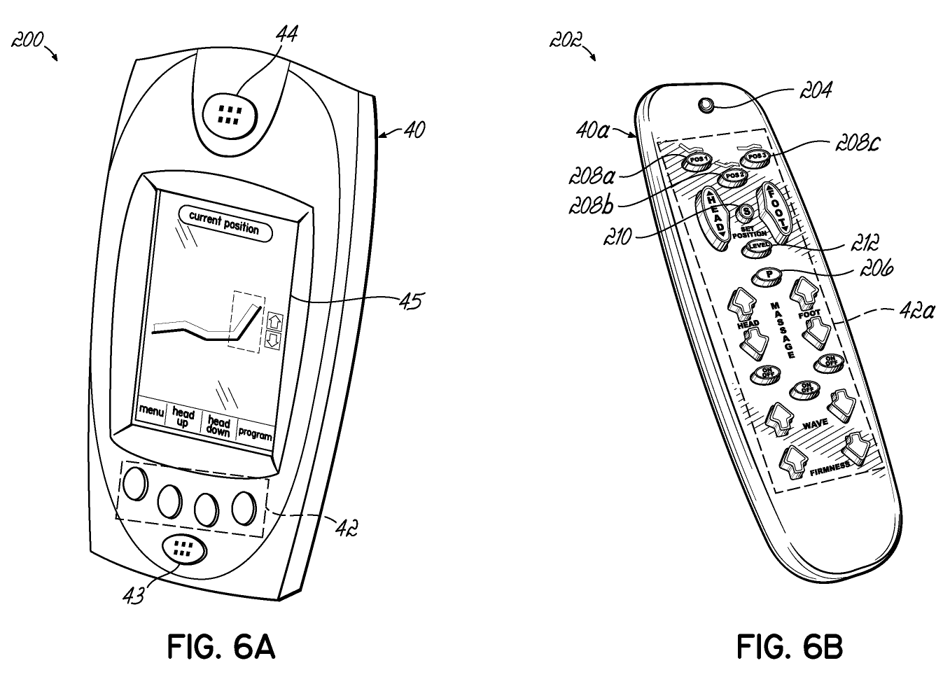

FIG. 6A is an illustration 200 of one embodiment of the remote controller 40 operable to receive interaction from the user. As shown in FIG. 6A, this embodiment of the remote controller 40 includes the manual input device 42, the microphone 43, the speaker 44, and the display 45. The user may be presented with various screens to control the actuable device elements, interact with the ICPMM 34, and in general control the adjustable bed. As illustrated in FIG. 6A, the remote controller 40 display 45 shows the current configuration of an adjustable bed, and, in particular, control options for the head 22 of the adjustable bed. By selecting an appropriate button on the manual input device 42, the head 22 of the adjustable bed may be raised or lowered. In an alternate embodiment, aspects of the manual input device 42 may be incorporated into the display 45, and the user may tap an appropriate representation on the display 45 to raise or lower the head 22 of the adjustable bed. Once the user interacts with the remote controller 40 to raise or lower the head 22, the remote controller 40 determines if the interaction is a valid command, and if it is, communicates that command to the ICPMM 34 which analyzes the command, determines that the command is to raise or lower the head, and raises or lowers the elevation unit for the head 22 appropriately. The remote controller 40 is operable to communicate with the ICPMM 34 to adjust each actuable device element and control various aspects of the ICPMM 34, including the light 76. Furthermore, the remote controller 40 is operable to create and view programs or other routines for the ICPMM 34 to adjust actuable device elements and receive indications of an execution status of each actuable device element.

FIG. 6B is an illustration 202 of an alternate embodiment of a remote controller 40a operable to receive interaction from the user and control the adjustable bed consistent with embodiments of the invention. As shown in FIG. 6B, this embodiment of the remote controller 40a includes the manual input device 42a and speaker 44 (internal to the remote controller 40a), but does not include the microphone 43 or display 45. However, remote controller 40a may include a status light 204 that may be operable to indicate when the remote controller 40a is communicating with the ICPMM 34, the execution status of a command (i.e., green for success, red for failure), or that another failure has occurred. The remote controller 40a of FIG. 6B is operative to communicate with the ICPMM 34 and raise or lower the head 22 and/or foot 22 of the adjustable bed, control massaging units (including turning each massaging unit off and on), produce a “wave” massaging effect with the massaging units by selectively energizing the massaging units (including turning the “wave” effect off and on), and control the firmness of the adjustable bed. The remote controller 40a of FIG. 6B is also operable to induce the ICPMM 34 to store currently configured elevations of the adjustable bed as “positions.” In this way, the user may store the current elevation of the adjustable bed in the memory 104 of the ICPMM 34 and recall it at a later time. The user stores the current elevation by pressing the P button 206 on the manual input device 42a, followed by pressing one of the POS1, POS2, or POS3 buttons 208a, 208b, or 208c. The user recalls a position, and thus sets the adjustable bed in that position, by pressing the SET POSITION button 210 on the manual input device 42a, followed by pressing one of the POS1, POS2, or POS3 buttons. The user completely levels the adjustable bed (i.e., communicates to the ICPMM 34 to reduce each elevation unit to their lowest positions) by pressing the LEVEL button 212 on the manual input device 42a.

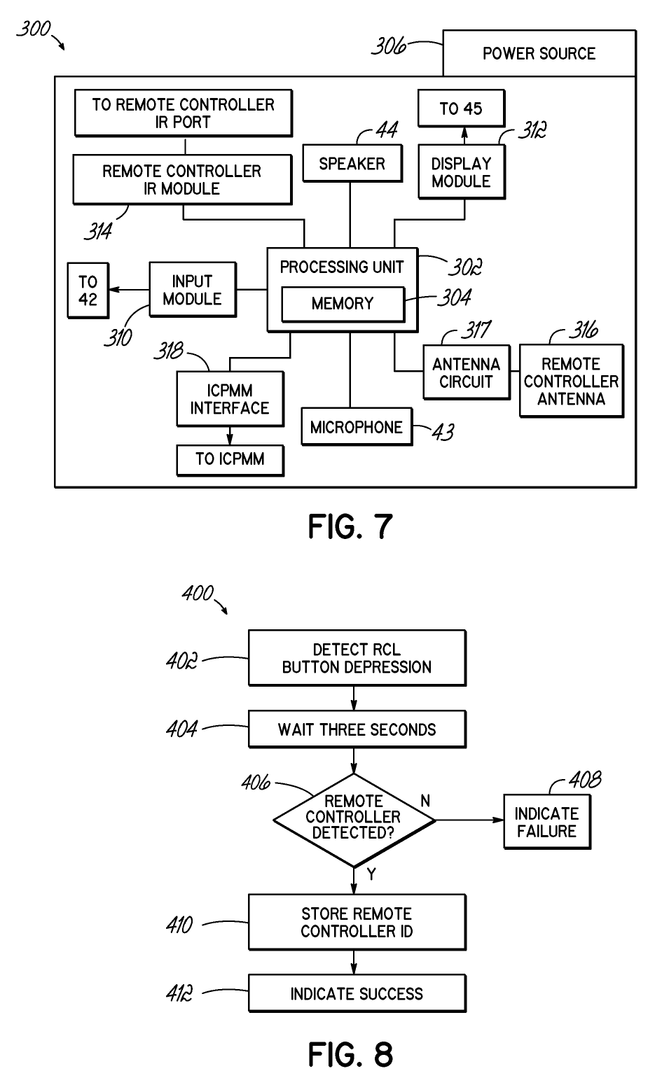

FIG. 7 is a schematic diagrammatical illustration 300 that generally illustrates components of one embodiment of a remote controller consistent with the present invention. The schematic illustration 300 illustrates an embodiment of circuitry that may be configured in the remote controller 40 of FIGS. 1-4 and 5, the remote controller 40a of FIG. 6, or other remote controllers operable to control adjustable furniture and receive information from the ICPMM 34 (collectively, “remote controller”). As shown in FIG. 7, the processing capabilities of the remote controller are handled by a remote controller processing unit (“RCPU”) 302 that may include a remote controller memory 304. The RCPU 302 may be one or more processors, controllers, or field programmable gate arrays, while the remote controller memory 304 can be random access memory devices, cache memories, non-volatile memories, and/or read-only memories. Remote controller memory 304 can additionally be part of the RCPU 302 or located elsewhere in the remote controller. In one embodiment, RCPU 302 includes one Freescale Semiconductor MC13212 series microcontroller.

As shown in FIG. 7, the remote controller includes a remote controller power source (RCPS) 306 that supplies energy from one or more remote controller power storage devices operable to provide a source of DC energy to power the remote controller. In some embodiments, each remote controller power storage device is a disposable battery, a rechargeable battery, a capacitor, or other power storage device as is well known in the art.

The remote controller includes a manual input module 310 to interface with the manual input device 42. The manual input module 310 is operable to detect which button or key of the manual input device 42 has been pressed. In embodiments of the remote controller where the manual input device 42 is integrated into the display 45, the manual input module 310 is operative to determine the location that the user has selected on the display 45 and input this information to the RCPU 302.

The remote controller in some embodiments includes the microphone 43 and speaker 44. In these embodiments, the microphone 43 is operative to convert sounds into electrical signals and relay those signals to the RCPU 302, which may process the electrical signals and convert them into machine readable input. In alternate embodiments, the RCPU 302 may relay the electrical signals to the ICPMM 34 to be converted into machine readable input. In some embodiments, the speaker 44 is operative to play a noise in response to a signal from the ICPMM 34, which may be itself in response to the user hitting the RCL button 84 on the ICPMM 34 or in response to a command from the remote controller. The speaker 44 may also be operative to play information to the user, including a sound indicating success or failure of the last command, the last recognized command, the execution status of commands, and/or information about the adjustable bed.

In some embodiments, the remote controller includes a display module 312 operative to interface with the display 45. In those embodiments, the display module 312 may be operative to display information about the adjustable bed, such as elevation of the adjustable bed, massaging profiles, firmness of the adjustable bed, routine programming interfaces, the execution status of commands, and/or errors and faults of the adjustable bed.

To communicate with the ICPMM 34, the remote controller may include a remote controller IR module 314, a remote controller antenna 316 and antenna circuit 317, and/or an ICPMM interface 318. The remote controller IR module 314 provides the capability for the remote controller to wirelessly communicate bi-directionally with the ICPMM 34 through IR. The remote controller IR module 314 may be coupled with a remote controller IR on the remote controller and communicate with the IR port 78 of the ICPMM 34 in a manner well known in the art, such as through the IRDA and/or CIR standard. The remote controller may also wirelessly communicate bi-directionally through a remote controller antenna 316 and antenna circuit 317. The antenna circuit 317 may be substantially the same as the circuit arrangement 135 of the ICPMM 34. In this way, the remote controller may receive and transmit RF signals through the remote controller antenna 316 and interact with the ICPMM 34 such that the remote controller antenna 316 and antenna circuit 317 operate as a remote controller transceiver.

The remote controller may further include the ICPMM interface 318 operable to communicate between the remote controller and ICPMM 34 when the remote controller is in electrical communication with the ICPMM 34 as shown in FIG. 4. Advantageously, when the ICPMM 34 is in electrical communication with the remote controller, the power storage units in the RCPS 306 may draw power from the ICPMM 34 to charge.

In general, the routines executed to implement the embodiments of the invention, whether implemented as part of an operating system or a specific application, component, algorithm, program, object, module or sequence of instructions, or even a subset thereof, will be referred to herein as “computer program code” or simply “program code.” Program code typically comprises one or more instructions that are resident at various times in memory and storage devices and that, when read and executed by the processing units 102 and 302, cause that processing unit 102 and 302 to perform the steps necessary to execute steps or elements embodying the various aspects of the invention. Moreover, while the invention has and hereinafter will be described in the context of adjustable beds, ICPMMs, and remote controllers, those skilled in the art will appreciate that the various embodiments of the invention are capable of being distributed as a program product in a variety of forms, and that the invention applies regardless of the particular type of computer readable media used to actually carry out the invention. Examples of computer readable media include, but are not limited to, recordable type media such as volatile and non-volatile memory devices, floppy and other removable disks, hard disk drives, tape drives, optical disks (e.g., CD-ROM's, DVD's, HD-DVD's, Blu-Ray Discs), among others, and transmission type media such as digital and analog communications links

In addition, various program code described hereinafter may be identified based upon the application or software component within which it is implemented in specific embodiments of the invention. However, it should be appreciated that any particular program nomenclature that follows is merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within the ICPMM and remote controller, it should be appreciated that the invention is not limited to the specific organization and allocation of program functionality described herein.

Those skilled in the art will recognize that the environments illustrated in FIGS. 1-7 are not intended to limit the present invention. Indeed, those skilled in the art will recognize that other alternative hardware environments may be used without departing from the scope of the invention.

FIG. 8 illustrates a flowchart 400 showing a process to configure a remote controller to communicate with an ICPMM 34 consistent with one embodiment of the invention. In block 402, the ICPMM 34 detects that the RCC button 82 has been depressed. This indicates that the ICPMM 34 may receive a remote controller signal that it can receive to configure a remote controller. In block 404, the ICPMM 34 monitors its inputs (i.e., IR port 78 and/or antenna 134) for remote controller signals for a time period of about three seconds. After that time period, the ICPMM 34 analyzes any received signals to determine if it received a remote controller signal in block 406. In one embodiment, the ICPMM 34 may analyze the received signals to determine if a signal corresponding to a particular manual input device signal has been received from a remote controller. For example, the particular manual input device signal may be two manual input device 42 or 42a buttons pressed at the same time. When the ICPMM 34 does not receive a remote controller signal with the particular manual input device signal, the ICPMM 34 indicates a failure in block 408. In particular, the ICPMM 34 may indicate a failure through the status indicator 74 or the ICPMM speaker 126.

When the ICPMM 34 has received a remote controller signal, the ICPMM 34 associates the remote controller with a remote identification (“ID”) supplied by the remote controller in block 410. Each remote controller is configured with a unique remote ID that includes a unique combination of numbers. When the remote controller transmits any data (i.e., commands, requests for information, other data) it sends the remote ID as part of the data. The ICPMM 34 is operable to store that remote ID in memory 104 and associate that remote ID with the remote controller. Once the remote ID is stored, the ICPMM 34 will ignore any received commands that do not include a stored remote ID, other than commands detected by depressions of buttons 80, 82, and 84. Furthermore, the ICPMM 34 will include that remote ID with any communications to that remote controller. In a similar manner as the ICPMM 34, a remote controller will ignore any received data that does not include its remote ID. In this way, the remote controller and ICPMM 34 are operable to communicate bi-directionally while advantageously avoiding cross-talk with other remote controllers or other ICPMMs 34.

By way of example, and in a specific embodiment, an adjustable bed consistent with embodiments of the invention that includes two sides controlled by separate ICPMMs 34 may be independently controlled by separate remote controllers. By configuring each ICPMM 34 with separate remote controllers, and therefore separate remote IDs, the ICPMMs 34 are unresponsive to cross-talk from other remote controllers as the ICPMMs 34 will only be responsive to remote controllers that transmit remote IDs that correspond to stored remote IDs.

In block 412, the ICPMM 34 indicates success. In particular, the ICPMM 34 may indicate success through the status indicator 74, the ICPMM speaker 126, or through the remote controller by instructing the remote controller to play a sound on the speaker 44 or display information on display 45.

To configure a second remote controller, the user may press the RCC button 82 again and configure the second remote controller on the ICPMM 34 in a substantially similar manner as that disclosed above illustrated in FIG. 8. In some embodiments, the ICPMM 34 is configured to accept the signals of, and store the remote IDs of, two remote controllers.

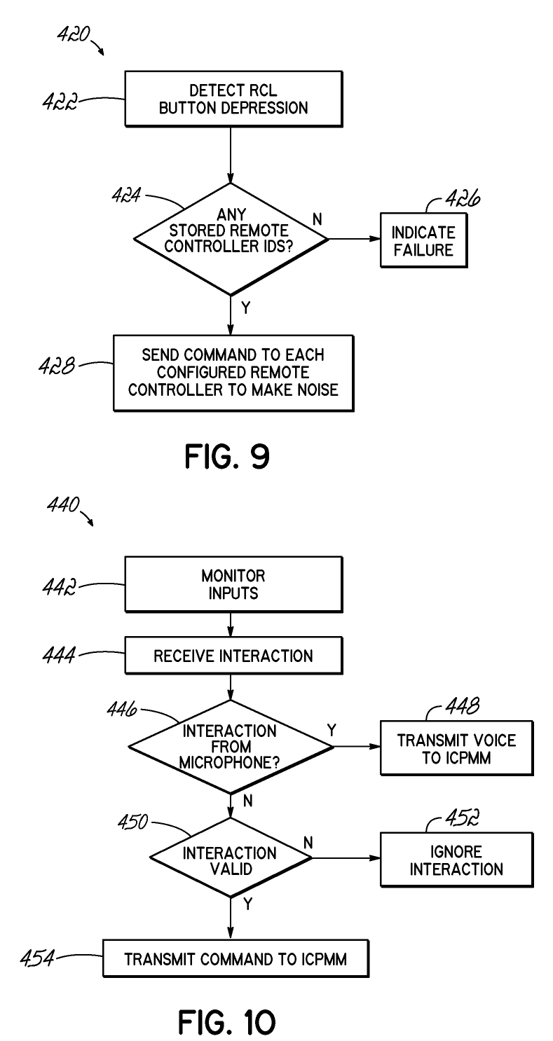

FIG. 9 illustrates a flowchart 420 showing a process to locate a remote controller consistent with one embodiment of the invention. In block 422, the ICPMM 34 detects that the RCL button 84 has been depressed. This commands the ICPMM 34 to send out a signal to locate one or more remote controllers that have previously been configured on ICPMM 34. In block 424, the ICPMM determines whether any remote IDs are stored in the memory 104. When there are no remote IDs, the ICPMM 34 indicates a failure at block 426. Again, the ICPMM 34 may indicate a failure through the status indicator 74 or the ICPMM speaker 126

When the ICPMM 34 is configured with one or more remote IDs, the ICPMM 34 sends out signals to those one or more remote controllers associated with those remote IDs to make a noise in block 428. Each signal may be sent out through the IR port 78, the remote controller port, and/or the antenna 134. If the remote controllers are able to receive the signals, the remote controllers will make a noise on their respective remote speakers 44.

FIG. 10 illustrates a flowchart 440 showing a process consistent with the remote controller receiving interaction from the user and transferring the command to the ICPMM 34. In block 442, the remote controller monitors the manual input device 42 or 42a and/or the microphone 43 for interaction from the user. The interaction may be a command to adjust the actuable device elements, or a command for the ICPMM 34 to transmit data to the remote controller. In one embodiment, the remote controller monitors the manual input device 42 or 42a for a button depression or other interaction and/or monitors the microphone 43 for a threshold noise level. In block 444, the remote controller receives interaction on the manual input device 42 or 42a or microphone 43.

In one embodiment, the remote controller determines whether the interaction came from the microphone 43 in block 446. In this embodiment, the remote controller transmits the interaction, which may be a voice command of the user, to the ICPMM 34 for processing in block 448. In one embodiment, the remote controller may not be configured to convert the voice of a user into machine readable data, while the ICPMM 34 is so configured. In alternate embodiments, such as when the remote controller is configured to convert the voice of the user into machine readable data, the remote controller determines if the interaction is a valid command in block 450. In this block, the remote controller may generally decode the interaction to determine if the interaction was a valid command. When the interaction was not a valid command (i.e., multiple buttons were pressed after configuration, the interaction was not completed, the interaction was an unintelligible noise) the interaction is ignored in block 452.

When the interaction is a valid command, the remote controller transmits the interaction to the ICPMM 34 in block 454. In blocks 448 and 454, the remote controller may transmit the interaction to the ICPMM 34 through a remote controller IR port, remote controller antenna 316, or ICPMM interface 318.

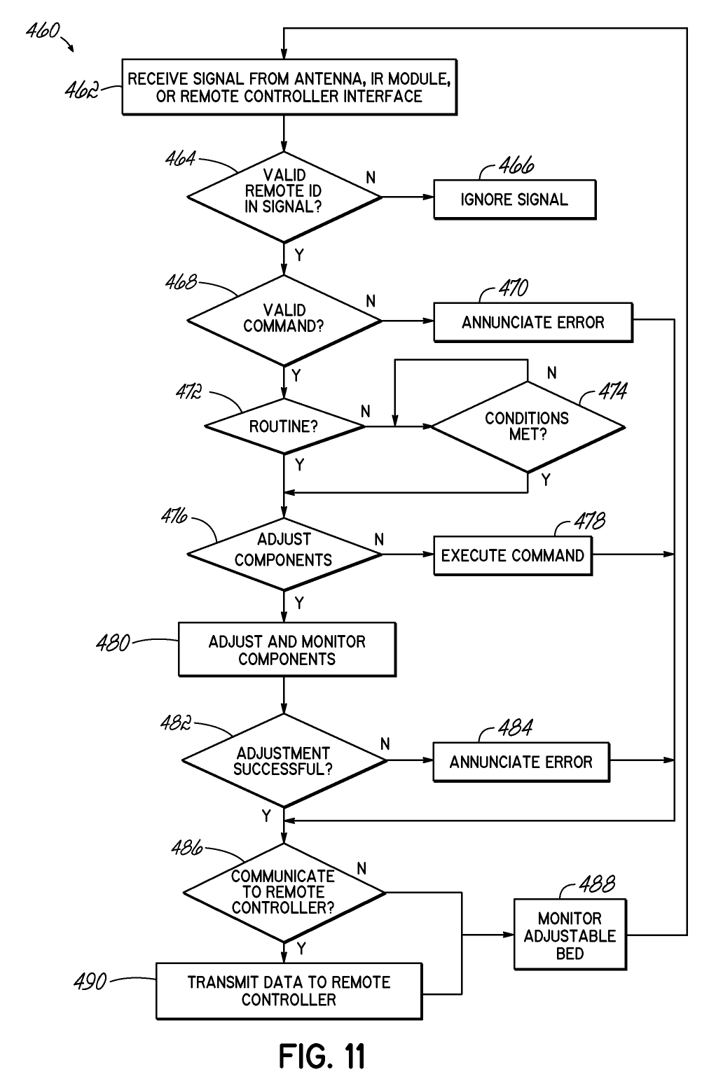

FIG. 11 illustrates a flowchart 460 showing a process consistent with the ICPMM 34 receiving and processing signals received on the antenna 134, the IR module 124, or the remote controller interface 136. In block 462, the ICPMM 34 receives a signal on the antenna 134, the IR module 124, or the remote controller interface 136. The ICPMM 34 analyzes this signal to determine whether it came from a remote controller in block 464. In block 464, the ICPMM 34 may analyze the signal to determine if it contains a valid remote ID (i.e., a remote ID that corresponds to a remote ID in memory 104). When the signal does not contain a valid remote ID, the ICPMM 34 ignores the signal in block 466.

When the signal contains a valid remote ID, the ICPMM 34 determines if the signal is a valid command in block 468. In one embodiment, the signal may be a voice of the user that the ICPMM 34 converts into machine readable input in block 468. In that embodiment, the ICPMM 34 then determines whether the machine readable input is a valid command in block 468. In other embodiments, the ICMM 34 analyzes the data in the signal to determine whether the signal includes a valid command in block 468. For example, and not intending to be limiting, the signal may experience interference, causing the command originally in the signal to become distorted. When the signal does not contain a valid command, the ICPMM 34 may annunciate an error in block 470. The ICPMM 34 may annunciate an error on the status indicator 74 and/or through the ICPMM speaker 126 in block 470. Additionally, the ICPMM 34 may store information about the error in block 470 in memory 104 and determine whether to annunciate the error in block 486.

When the signal contains a valid command, the ICPMM 34 determines if the command is a routine in block 472. In one embodiment, the signal may include a routine for the ICPMM 34 to execute. As such, the routine may include conditions that must be met before the routine execution. In block 474, the ICPMM 34 determines if the conditions for a routine have been met. The condition check in block 474 may be configured to run in the background so as not to use too many resources of the ICPMM 34. For example, and not intending to be limiting, one suitable condition may be a time for the routine to run or otherwise adjust an actuable device element.

When the signal does not contain a routine, or when routine conditions have been met, the ICPMM 34 determines whether the command is to adjust at least one actuable device element in block 476. In one embodiment, the signal does not include a command to adjust at least one actuable device element. In this embodiment, the ICPMM 34 executes the command in block 478. For example, and not intending to be limiting, the command executed in block 478 may be to send information to the remote controller.

When the command instructs the ICPMM 34 to adjust at least one actuable device element, the ICPMM 34 adjusts the at least one actuable device element and monitors the at least one actuable device element with at least one sensor 58 in block 480. In this way, the ICPMM 34 may determine the status of the command as it is executed. For example, and in one specific embodiment, the command may be to raise the head 22 of the adjustable bed by one inch. As the ICPMM 34 elevates the elevation unit for the head 22, a sensor 58 may determine the change in elevation as the head 22 is raised and generate a sensor signal that is received by the ICPMM 34. In this way, the ICPMM 34 may be operable to receive feedback from sensors 58 as the actuable device elements are adjusted, and convert this feedback into an execution state. In block 482, the ICPMM 34 determines whether the adjustment was successful. The ICPMM 34 may determine that the adjustment has been successful from information gathered by the sensors 58. In block 484, the ICPMM 34 annunciates an error when the adjustment has not been successful. The ICPMM 34 may annunciate an error on the status indicator 74 and/or through the ICPMM speaker 126 in block 484. Additionally, the ICPMM 34 may store information about the error in block 484 in memory 104 and determine whether to annunciate the error in block 486.

After the annunciation of errors in block 470 or 484, the execution of a command in block 478, or the successful adjustment of an adjustable bed component in block 482, the ICPMM 34 may communicate information to the remote controller to be annunciated on the speaker 44 or display 45. For example, the ICPMM 34 may communicate the execution status of a command. In block 486, the ICPMM 34 determines whether to communicate to the remote controller to play a sound on the speaker 44 or make an indication on display 45. The ICPMM 34 may determine that it should communicate to the remote controller when there is an error to report, when the remote controller has requested information be sent, an indication of the last command translated from the users voice, when there is an execution status to send to the remote controller, and/or in response to adjustment of the at least one component of the adjustable bed. When the ICPMM 34 determines not to communicate to the remote controller, the ICPMM 34 returns to monitoring the adjustable bed in block 488. When the ICPMM 34 determines that it should communicate the information to the remote controller the, ICPMM 34 sends the information in block 490, then returns to monitoring the adjustable bed in block 488.

While the present invention has been illustrated by a description of various embodiments and while these embodiments have been described in considerable detail, it is not the intention of the applicants to restrict, or in any way limit, the scope of the appended claims to such detail. As such, additional advantages and modifications will readily appear to those skilled in the art. For example, one having skill in the art will appreciate that the blocks in the flowcharts of FIGS. 7-11 may be re-ordered without departing from the scope of the invention. The invention in its broader aspects is therefore not limited to the specific details, representative apparatus and method, and illustrative example shown and described. Accordingly, departures may be made from such details without departing from the scope of applicant's general inventive concept.

What is claimed is:

1. A system for controlling a piece of adjustable furniture of the type that includes an adjustable configuration parameter, the system comprising:
a remote controller operable to receive a command from a user to adjust the adjustable configuration parameter;
a control unit in communication with the remote controller, the control unit operable to receive the command from the remote controller, the control unit further operable to control the adjustment of the adjustable configuration parameter;
an actuable device element in electrical communication with the control unit, the actuable device element operable to adjust the adjustable configuration parameter; and
a sensor electrically connected to the actuable device element and the control unit, the sensor operable to measure the adjustment of the adjustable configuration parameter and to generate a sensor signal,
wherein the control unit is operable to receive the sensor signal and determine an execution status of the command, and
wherein the control unit is further operable to send the execution status of the command to the remote controller, and
wherein the remote controller is operable to indicate the execution statues of the command.

2. The system of claim 1, wherein the remote controller and control unit are in wireless communication through a wireless communication selected from the group consisting of: radio frequency communication, infrared communication, and combinations thereof.

3. The system of claim 2, wherein the wireless communication is bi-directional between the control unit and the remote controller.

4. The system of claim 1, wherein the control unit further comprises:
a light operable to illuminate in response to a command received from the remote controller at the control unit.

5. The system of claim 1, wherein the adjustable configuration parameter is an elevation of a portion of a surface of the piece of adjustable furniture, and wherein the actuable device element is an elevation unit that further comprises:
a motor in electrical communication with the control unit;
a linear actuator coupled to the motor, the linear actuator operable to expand and contract in response to a rotary motion of the motor, wherein the elevation unit is operable to adjust the elevation of the portion of the surface of the piece of adjustable furniture.

6. The system of claim 1, wherein the adjustable configuration parameter is a massaging characteristic of the piece of adjustable furniture, and wherein the actuable device element is a massaging unit operable to adjust the massaging characteristic of the piece of adjustable furniture.

7. The system of claim 1, wherein the adjustable configuration parameter is a pressure of a surface of the piece of adjustable furniture, and wherein the actuable device element is a pump operable to adjust the pressure of the piece of adjustable furniture.

8. The system of claim 1, wherein the command includes program code operable to be executed by the control unit to adjust the adjustable configuration parameter.

9. The system of claim 1, wherein the remote controller further comprises:
a manual input device operable to receive the command.

10. The system of claim 1, wherein the remote controller further comprises:
a microphone operable to convert a voice of the user into an electrical signal.

11. The system of claim 10, wherein the remote controller is operable to convert the electrical signal into the command.

12. The system of claim 10, wherein the remote controller is operable to communicate the electrical signal to the control unit, and wherein the control unit is operable to convert the electrical signal into the command.

13. The system of claim 1, wherein the remote controller receives the execution status, and wherein the remote controller further comprises:
a speaker to indicate the execution status.

14. The system of claim 1, wherein the remote controller receives the execution status, and wherein the remote controller further comprises:
a display to indicate the execution status.

15. The system of claim 1, wherein the control unit further comprises:
a status indicator operable to indicate the execution status of the command.

16. The system of claim 1, wherein the control unit further comprises:
a processing unit; and
a memory in electrical communication with the processing unit, the memory operable to store a preprogrammed routine, the control unit operable to execute the preprogrammed routine to adjust the adjustable configuration parameter in compliance with the preprogrammed routine.

17. The system of claim 1, wherein the piece of adjustable furniture is an adjustable bed, wherein the adjustable bed further comprises:
a right side that further comprises a head and a foot portion; and
a left side the further comprises a head and a foot portion, wherein the control unit is operable to independently control the left and right sides.

18. The system of claim 1, the control unit further comprising:
a remote controller location button electrically connected to the control unit, the remote controller location button operable to cause the control unit to send a signal to the remote controller to make a noise.

19. A method for controlling a piece of adjustable furniture of the type that includes an adjustable configuration parameter, the method comprising:
receiving a command from a user at a remote controller to adjust the adjustable configuration parameter;
communicating the command from the remote controller to a control unit, the control unit operable to control the adjustment of the adjustable configuration parameter;
adjusting the adjustable configuration parameter with an actuable device element in electrical communication with the control unit;
measuring the adjustment of the adjustable configuration parameter with a sensor electrically connected to the actuable device element and the control unit;
in response to measuring the adjustment of the adjustable configuration parameter with the sensor, generating a sensor signal with the sensor operable to be received by the control unit;
determining from the sensor signal an execution status of the command at the control unit; and
indicating the execution status of the command on the remote controller.

20. The method of claim 19, wherein the remote controller and control unit wirelessly communicate through a wireless communication selected from the group consisting of: radio frequency communication, infrared communication, and combinations thereof.

21. The method of claim 20, wherein the wireless communication is bi-directional between the control unit and the remote controller.

22. The method of claim 19, further comprising:
illuminating a light on the control unit in response to a command received at the control unit and from the remote controller.

23. The method of claim 19, wherein the command is program code, the method further comprising:
executing the program code with the control unit to adjust the adjustable configuration parameter.

24. The method of claim 23, further comprising:
storing the program code in a memory of the control unit.

25. The method of claim 19, wherein the control unit comprises a processing unit and a memory in electrical communication with the processing unit, the method further comprising:
storing a program code in a memory; and
executing, with the control unit, the preprogrammed routine to adjust the adjustable configuration parameter.

26. The method of claim 19, wherein the piece of adjustable furniture is an adjustable bed with a right side and a left side that each comprise a head and a foot portion, the method further comprising:
independently controlling the left and right sides.

27. The method of claim 19, further comprising:
detecting a depression of a remote controller location button configured on the control unit; and
in response to detecting the depression of the remote controller location button, sending a signal from the control unit to the remote controller, wherein the signal instructs the remote controller to make a noise.

28. A method for controlling a piece of adjustable furniture with a control unit, wherein the piece of adjustable furniture is of the type that includes an adjustable configuration parameter, the method comprising:
receiving a command from a remote controller in communication with the control unit to adjust the adjustable configuration parameter;
adjusting the adjustable configuration parameter by selectively energizing an actuable device element in electrical communication with the control unit;
in response to adjusting the adjustable configuration parameter, receiving a sensor signal generated by a sensor, wherein the sensor is operable to measure the adjustment of the adjustable configuration parameter;
analyzing the sensor signal to determine an execution status of the command; and
sending the execution status to the remote controller.

29. The method of claim 28, wherein the control unit and remote controller wirelessly communicate through a wireless communication selected from the group consisting of: radio frequency communication, infrared communication, and combinations thereof.

30. The method of claim 29, wherein the wireless communication is bi-directional between the control unit and the remote controller.

31. The method of claim 28, further comprising:
detecting a depression of a remote controller location button configured on the control unit; and
in response to detecting the depression of the remote controller location button, sending a signal from the control unit to the remote controller, wherein the signal instructs the remote controller to make a noise.

32. A method for controlling a piece of adjustable furniture of the type that includes a first and second side, wherein the first side includes a first adjustable configuration parameter and is controlled by a first control unit, and wherein the second side includes an adjustable configuration parameter and is controlled by a second control unit, the method comprising:
configuring a first remote controller to bi-directionally and wirelessly communicate with the first control unit, wherein the first remote controller and first control unit communicate through radio frequency communication;
configuring a second remote controller to bi-directionally and wirelessly communicate with the second control unit, wherein the second remote controller and second control unit communicate through radio frequency communication;
detecting a first command from the first remote controller to adjust the first adjustable configuration parameter at both the first and second control unit; and
detecting a second command from the second remote controller to adjust the second adjustable configuration parameter at both the first and second control unit,
wherein the first command is ignored by the second control unit and the second command is ignored by the first control unit such that the first control unit is independently controlled by the first remote controller and the second control unit is independently controlled by the second remote controller.

33. A method for locating a remote controller configured to bi-directionally and wirelessly communicate with a control unit through radio frequency communication, wherein the control unit is operable to control a piece of adjustable furniture of the type that includes an adjustable configuration parameter, the method comprising:
detecting a depression of a remote controller location button; and
in response to detecting the depression of the remote controller location button, sending a signal from the control unit to the remote controller, wherein the signal instructs the remote controller to make a noise on a speaker.
